(19) United States
(12) Patent Application Publication
(10) Pub. No.: US 2007/0000939 A1
(43) Pub. Date: Jan. 4, 2007

(54) DEVICE FOR HANDLING AND ORIENTATING PILLS OR TABLETS IN A PRECISE MANNER

(75) Inventor: Vasilios Vasiadis, Astoria, NY (US)

Correspondence Address: WILLIAM COLLARD;COLLARD & ROE, P.C., 1077 NORTHERN BOULEVARD, ROSLYN, NY, 11576, US

(73) Assignee: Vasilios VASIADIS, Astoria, NY (US)

(21) Appl. No.: 11/380,193

(22) Filed: Apr. 25, 2006

Related U.S. Application Data
(63) Continuation-in-part of application No. 10/872,882, filed on Jun. 21, 2004.
Application No. 10/872,882 is a continuation-in-part of application No. 10/697,631, filed on Oct. 29, 2003.
(63) Continuation-in-part of application No. 10/697,631, filed on Oct. 29, 2003.
(60) Provisional application No. 60/675,006, filed on Apr. 25, 2005.
(60) Provisional application No. 60/422,179, filed on Oct. 29, 2002.

(51) Int. Cl. B65G 59/00

(52) U.S. Cl. 221/264

(57) ABSTRACT

A system for dispensing items comprising a base and at least one wheel rotatably coupled to the base. There is also at least one actuator slidably disposed the wheel. This actuator is for retaining the item to be dispensed from the system. There is also at least one optical recognition system disposed adjacent to the wheel. This optical recognition system is for identifying at least one characteristic of the item to be dispensed to selectively actuate the actuator to dispense the item to be dispensed. The optical recognition system can be in the form of a camera or an electric eye to recognize a visual feature of an item to be dispensed such as a tablet or a pill.

### CROSS REFERENCE TO RELATED APPLICATIONS

This application is a non provisional application and claims priority from provisional application Ser. No. 60/675,006, this application is also a continuation in part application and claims priority under 35 U.S.C. 120 from U.S. patent application Ser. No. 10/872,882 filed on Jun. 21, 2004, which is a continuation in part application of 10/697,631 filed on Oct. 29, 2003, wherein that application claims priority under 35 U.S.C. 119(e) from U.S. provisional application 60/422,179 filed on Oct. 29, 2002.

### BACKGROUND OF THE INVENTION

The present invention relates to a pill or tablet analysis device which can be used to analyze pills or tablets in a precise manner. Other pill distribution systems are known in the art. For example, U.S. Pat. Nos. 6,220,481; 6,227,345; 5,984,079; 5,826,696; and 3,356,260 are known in the art and are hereby incorporated herein by reference.

### SUMMARY OF THE INVENTION

The invention relates to a pill or tablet handling device that includes a wheel that has a plurality of reception slots for receiving a pill or tablet oriented in a particular manner.

Essentially, the invention relates to a system for dispensing items comprising a base or stand and at least one wheel rotatably coupled to the base. There is also at least one actuator slidably disposed the wheel. This actuator is for retaining the item to be dispensed from the system. There is also at least one optical recognition system disposed adjacent to the wheel. This optical recognition system is for identifying at least one characteristic of this item to be dispensed, to selectively actuate the actuator to dispense this item. The optical recognition system can be in the form of a camera a measuring laser system or an electric eye to recognize a visual feature of an item to be dispensed such as a tablet or a pill. In at least one embodiment of the invention, this visual feature can be in the form of a laser burned hole print or bar code in the pill.

This device can also include least one hopper for feeding items to be dispensed into a position adjacent to the actuator.

To hold and selectively dispense the items to be dispensed, the wheel can comprise at least one wing or extension having a notch for receiving an individual pill or tablet from the hopper. The wheel can include at least one recess, and at least one slot for receiving an actuator for selectively retaining a pill. The actuator can include an actuator block, a spring and an actuator arm. Each recess is for receiving each actuator block and each associated spring while each slot is for receiving each actuator arm.

This system also can include least one cam for selectively actuating the actuator, wherein when the actuator is activated it can be used to dispense the item from the associated wheel. In this case, the actuator can comprise at least one actuator wheel wherein the actuator wheel can be selectively contacted by the cam to cause the actuator to slide in the wheel causing the actuator arm to slide away from the item to be dispensed thereby releasing and dispensing the item from the wheel.

While the wheel is turning, each item to be dispensed from the wheel is viewed by the optical recognition system to determine whether the item to be dispensed should be sent down an associated accept chute or an associated reject chute. In this case, the optical recognition system can be coupled to the stand via an optical support element.

This optical support element can be in the form of at least two holding elements with a first holding element for holding a first optical recognition element such as a camera on one side of the wheel, and a second holding element for holding a second optical recognition element such as a camera on an opposite side the wheel.

Essentially, a computer or processor is in communication with the cameras or both optical recognition elements wherein the computer has a predefined set of optical parameters to determine whether to accept or reject an item to be dispensed. In at least one embodiment, this item to be dispensed can be in the form of a tablet or a pill. Upon visual recognition, the computer would determine whether the pills would be dispensed into either the accept chute or the reject chute. In at least one embodiment, the wheel which selectively retains the pills in a wing region, has an actuator selectively retaining these pills in the wheel. When the camera identifies that the pill is unacceptable, a piston or solenoid actuating element would adjust its position to cause a reject cam to rotate to then actuate against the selected actuator wheel to cause the actuator block to slide against the spring to dispense the pill into a reject chute. At this point, the wheel may slow or stop to ensure ejection of the appropriate pill.

If the camera identifies that this pill is acceptable, then the wheel continues to turn past the reject chute without contacting the reject cam, wherein the actuator contacts an accept cam to eject the pill or tablet into the accept chute. This accept cam is elongated so that as the wheel continues to turn in a clockwise manner past the accept chute the cam continues to actuate the actuators in contact with that cam to open up a receipt slot or notch in the wheel to accept a new tablet to be dispensed from the hopper.

Each tablet is then unloaded from a slot in the hopper wherein each tablet in the hopper can then slide into the receipt slot or notch in the wheel. The tablets align in these notches or slots so that they can be easily viewed by the cameras disposed adjacent to the wheel. The tablets are held in place by the actuator arm which is pushed against the tablet via the actuator spring acting on the actuator block.

In this way, quality control over these tablets is ensured so that a poorly designed tablet which is optically recognizable can be rejected from the group. For example, tablets that have a time release coating may also have a hole burned into them from a laser burning system. An improperly drilled hole would alter the time release on the pill or tablet. This device can be used to ensure that each tablet has at least one properly burned hole. If the tablet does not contain a properly burned hole, then that tablet is removed from the group of acceptable tablets and sent through the reject chute.

### BRIEF DESCRIPTION OF THE DRAWINGS

Other objects and features of the present invention will become apparent from the following detailed description considered in connection with the accompanying drawings. It should be understood, however, that the drawings are designed for the purpose of illustration only and not as a definition of the limits of the invention.

In the drawings, wherein similar reference characters denote similar elements throughout the several views:

FIG. 1 is a perspective view of the first embodiment of the device;

FIG. 2 is a side perspective view of the device shown in FIG. 1;

FIG. 3 is a top perspective view of the device shown in FIG. 1;

FIG. 4 is a side view of the device shown in FIG. 1;

FIG. 5 is a front-side perspective view of the device with the hopper present;

FIG. 6 is a front perspective view of the wheel and hopper removed from the device shown in FIG. 1;

FIG. 7 is a perspective view opposite to that shown in FIG. 6 with the base plate removed;

FIG. 8 is a side perspective view of the device with the base plate being removed;

FIG. 9 is a perspective view of the wheel with a top removed;

FIG. 10 is a perspective view of the holders;

FIG. 11 is a perspective view of a single holder shown in FIG. 10;

FIG. 12 is a perspective view of a wheel with the holders with a top removed;

FIG. 13 is a perspective view of a wheel with a top on it;

FIG. 14 is a perspective view of the hopper;

FIG. 15 is an opposite side perspective view of the hopper shown in FIG. 14;

FIG. 16 is a perspective view of the device shown in FIG. 1 without the wheel shown;

FIG. 17 is a perspective view of the device without the hopper or the wheel shown;

FIG. 18 is a perspective view of the holder shown in FIG. 17;

FIG. 19 shows a perspective view of another embodiment of the invention;

FIG. 20 is a perspective view of a set of blocks;

FIG. 21 is a perspective view of the base for the wheel shown in FIG. 19;

FIG. 22 is a side cross-sectional view of the cover plate.

### DETAILED DESCRIPTION OF PREFERRED EMBODIMENTS

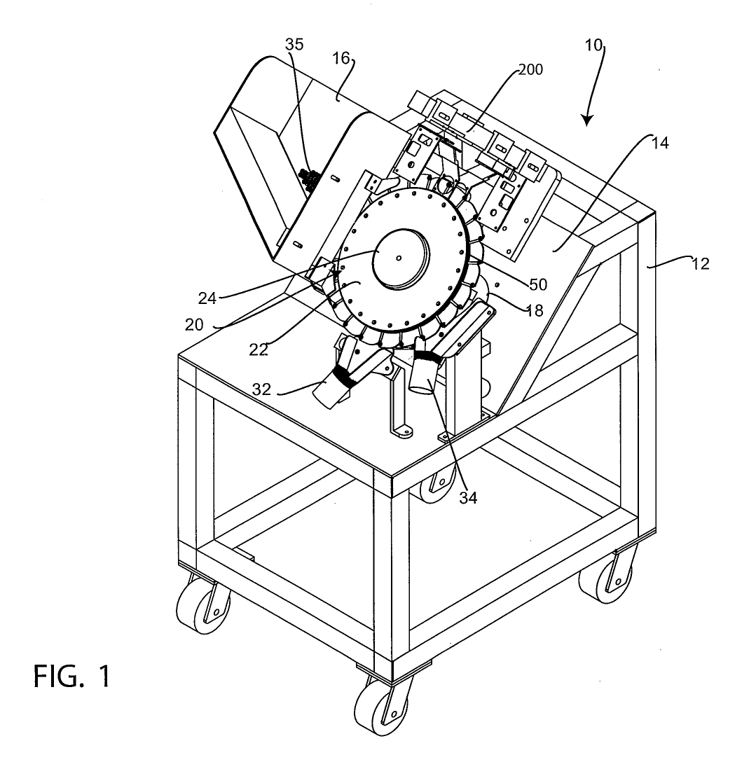

Referring to the drawings, FIG. 1 is a perspective view of a first embodiment of the invention wherein in this view, there is a device for dispensing tablets or pills. This device includes a stand or base 12, a base plate 14, coupled to the stand 12. There is a hopper 16 for dispensing these tablets into a wheel 20.

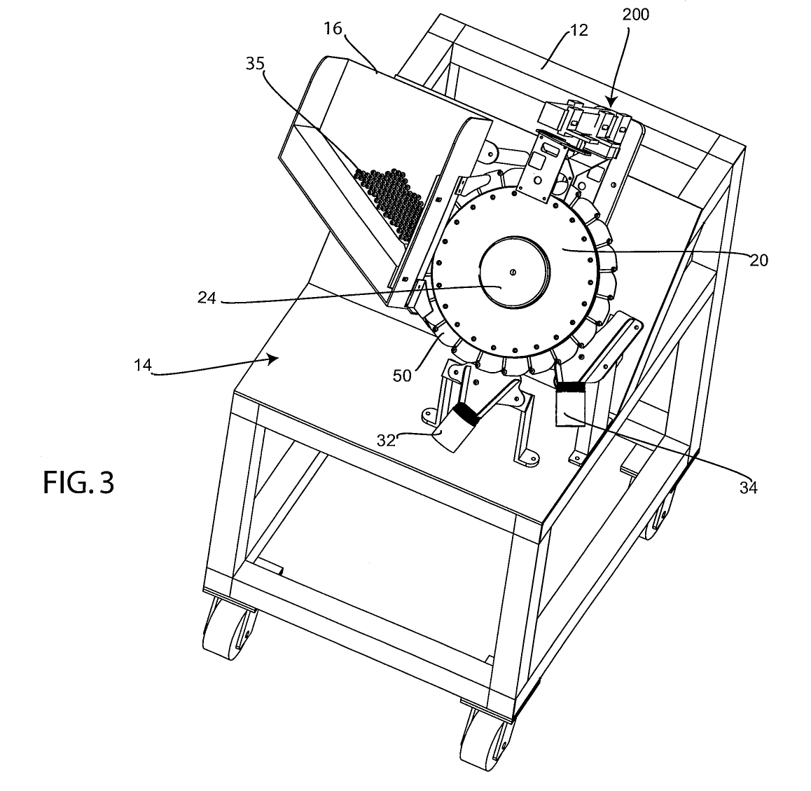

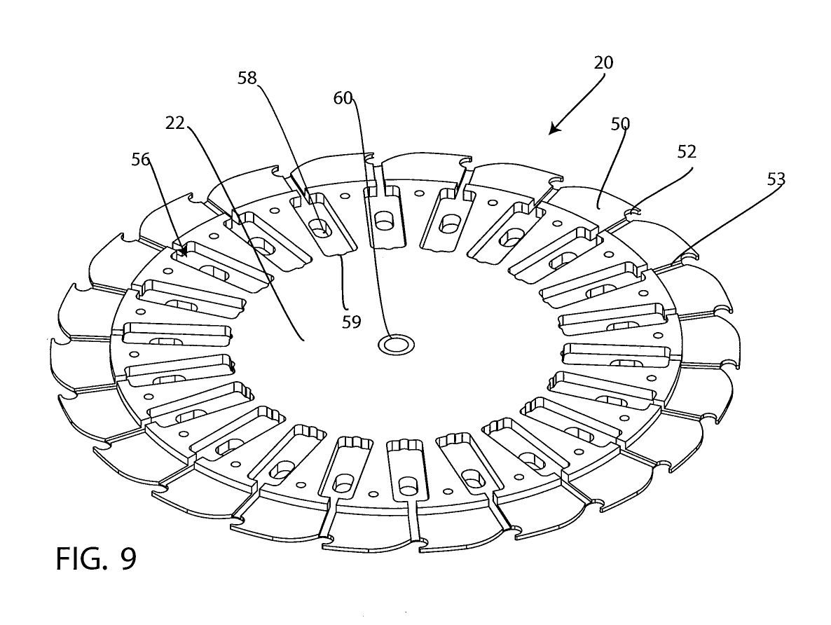

Wheel 20 includes an inner wheel 24 and an outer wheel 22. Inner wheel 24 is coupled to a rotary drive motor 18 (See FIG. 3) while outer wheel is coupled to a holding element in the form of wings, extension elements or flanges 50 (See FIG. 9) wherein wings 50 are for holding or presenting tablets 35.

Disposed adjacent to wheel 20 are at least two chutes, wherein there is a reject chute 34 and an accept chute 32 disposed adjacent to reject chute 34. These chutes are coupled to stand 12. An optical support system 200 is also coupled to stand 12 wherein this optical support system is for reviewing and analyzing tablets in wheel 20.

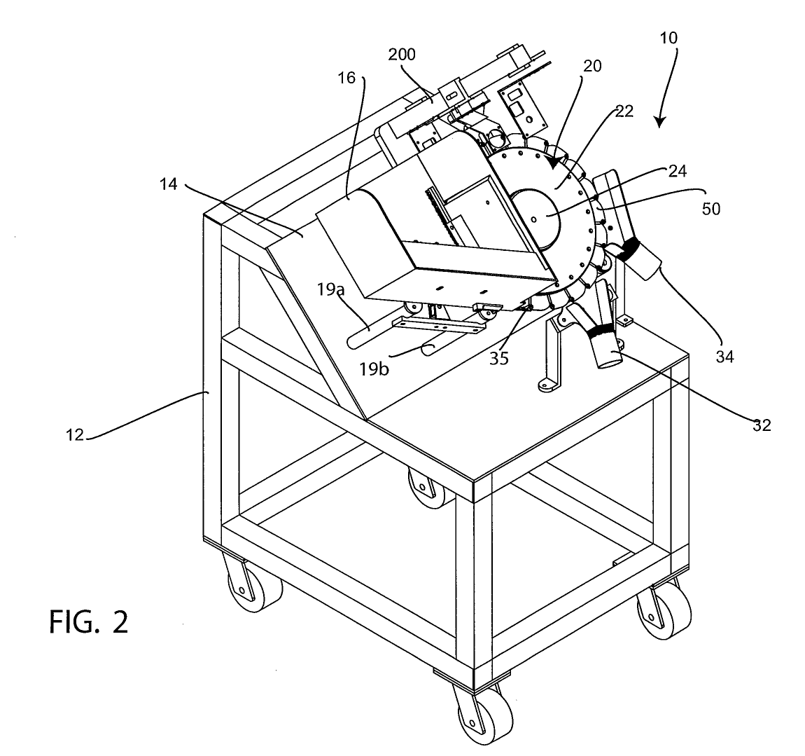

FIG. 2 shows an opposite perspective view of this device wherein tablets 35 are disposed inside of hopper 16 and are selectively dispensed out from a hole in hopper 16 so that these tablets 35 can feed into a retainer or tablet holder which is in the form of an indent, notch, hole, or reception area 52 (see FIG. 9) in wings 50.

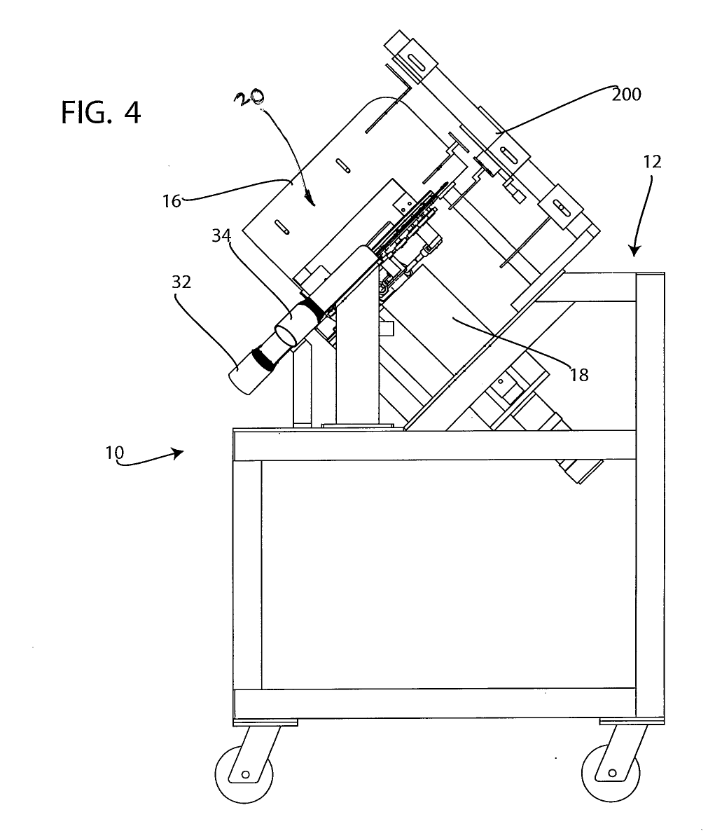

FIG. 4 shows that this device, particularly wheel 20 is positioned on an approximately 45 degree angle so that tablets 35 can be dispensed at least partially using a gravitational force. Because wheel 20 is positioned at this angle, tablets that are inserted into reception areas 52 will remain in these areas while wheel 20 is spinning. Thus, because of this positioning, the release of the holding element or pill will cause the pill to slide down a slot and into an adjacent reception area.

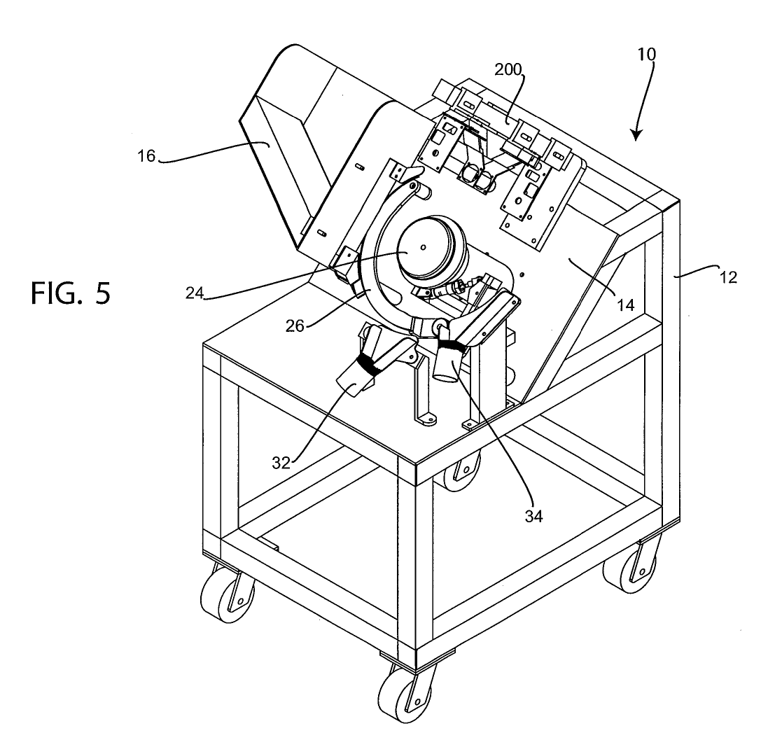

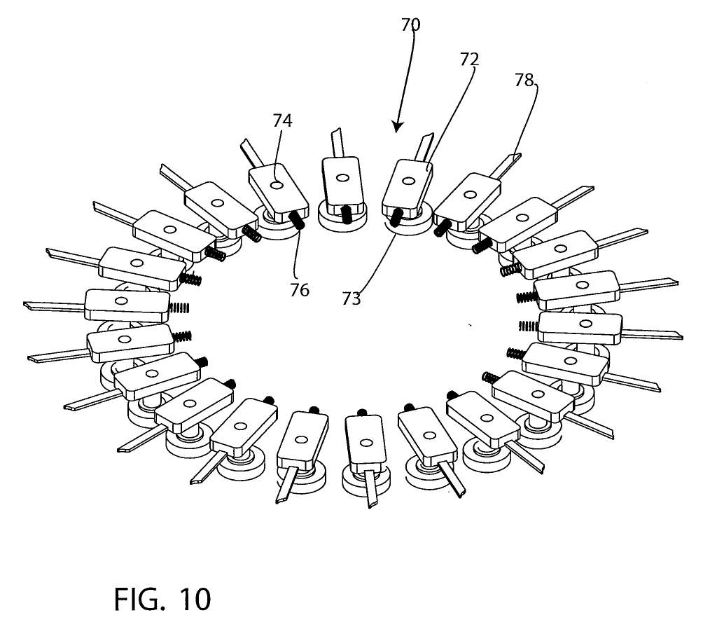

FIG. 5 shows this device with wheel 20 removed. In this view, a dispensing rim or cam 26 is exposed wherein this dispensing rim 26 is curved and has at least a first region that is disposed adjacent to accept chute 32. Cam 26 is designed to contact a plurality of actuator wheels 73 (See FIG. 10) which then react by opening a leaf or arm that is blocking or keeping a tablet or pill in reception area 52 to allow a tablet to be dispensed into accept chute 32. Thus, in this design, dispensing rim 26 is positioned so that when wheel 20 rotates in a clockwise manner, the cam wheels 73 will contact this cam 26 at, or just before an associated reception area 52 reaches accept chute 32 so that these tablets can be dispensed into accept chute 32.

In addition, cam 26 continues to curve around along a path of actuator wheels so that any associated actuator wheels 73 would still be retracted when reception area 52 reaches a region where hopper 16 would be dispensing tablets into wheels 20. This keeps each reception area 52 open so that pills 35 can slide into each area.

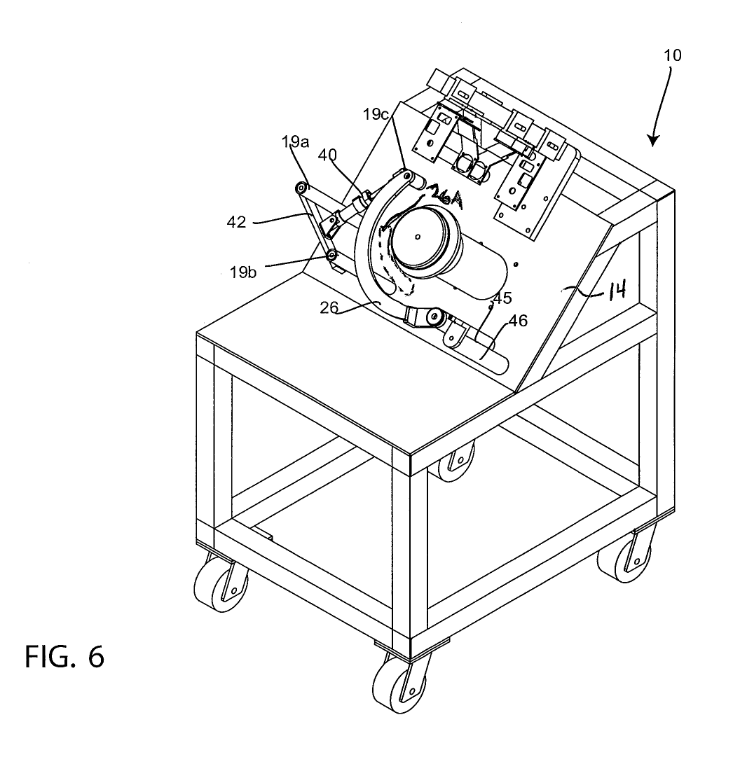

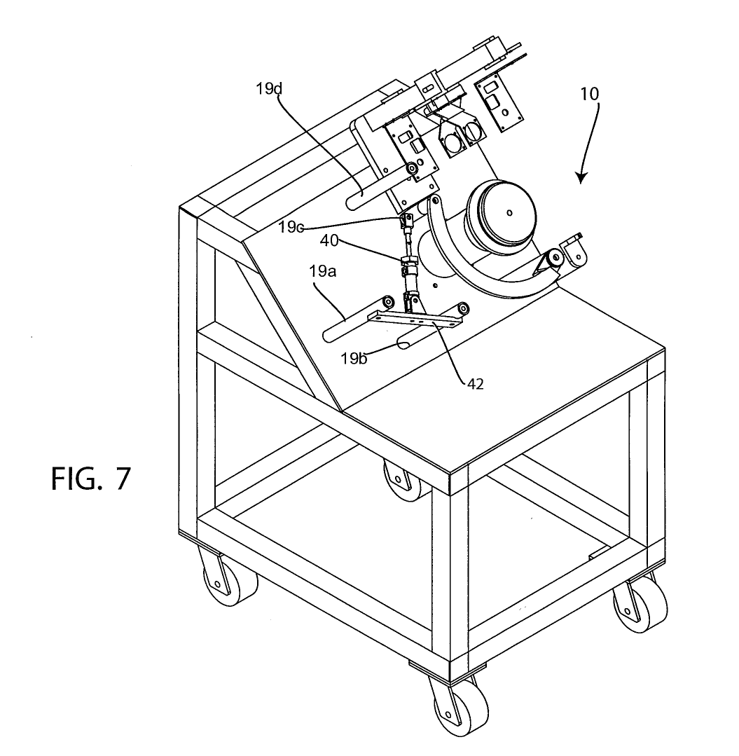

FIG. 6 is a front perspective view of the device with the hopper removed. With this design, there is shown a plurality of columns 19a, 19b and 19c which are coupled to base plate 14. In this case, columns 19a and 19b are used to support a base bracket 42 and a cylinder 40. Cylinder 40 is attached at one end to base bracket 42 and at an opposite end to cam 26 which is also supported by column 19c. Cam 26 is coupled at an opposite end to a rotating column or hinge 45 and a support shaft or column 46. Support shaft or column 19c is slidable along base plate 14 so that cam 26 can be rotated about shaft 45. Cam 26 can be rotated so that it can move from a first position, wherein it is positioned so that it can be set to contact associated cam wheels to release tablets or pills when the wheel rotates in a clockwise manner. Cam 26 can also be rotated around shaft 45 so that it can move into a second position wherein cam 26 rotates in a counter clockwise manner around column 45 to move away from wheel 20 so that cam 26 does not interact with cam wheel 73 (See FIG. 7) so that the tablets disposed in the wheel are retained.

FIG. 7 shows an opposite side perspective view of the device shown in FIG. 6. In this view, cylinder 40 is shown connecting from base bracket 42 to slidable block or column 19c. There is also shown an additional column 19d wherein columns 19a, 19b and 19d are support elements for supporting hopper 16.

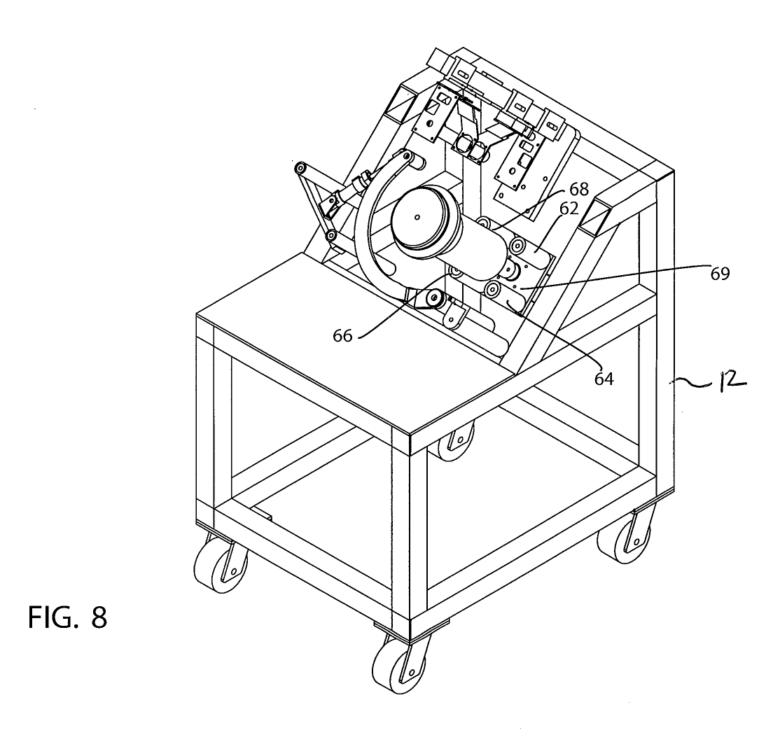

FIG. 8 shows a perspective view of the device shown in FIG. 6 with the base plate removed. In this view, there is shown additional support columns 62, 64, 66, and 68 which are supported on a bottom base plate 69. Bottom base plate 69 is coupled to frame 12 while support columns 62, 64, 66, and 68 are supported on bottom base plate 69 and are used to support base plate 14 shown in FIG. 1.

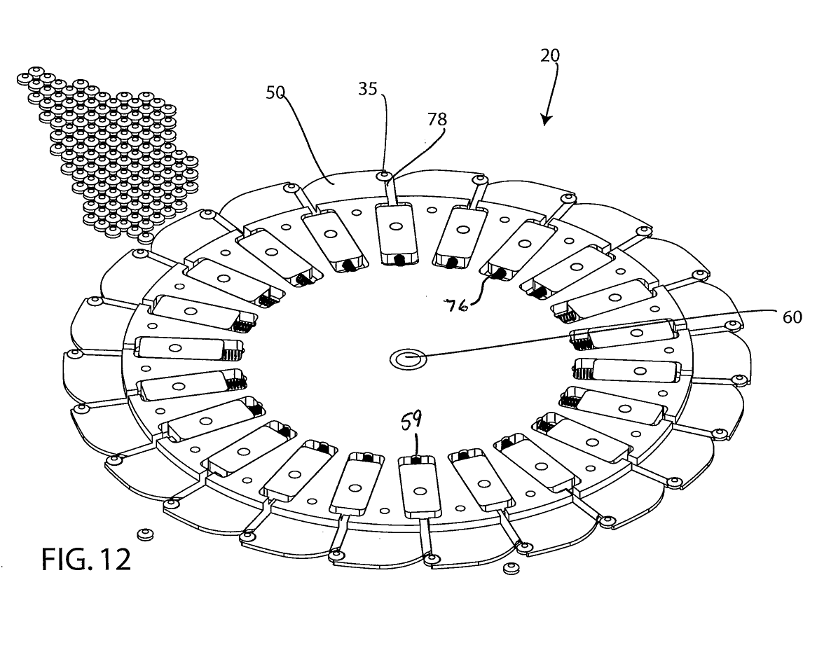

FIG. 9 is a front perspective view of wheel 20 removed from the device shown in FIG. 1. Wheel 20 includes wheel section 22 and also a hole 60 wherein hole 60 is designed to couple to an axle (not shown) coupled to rotatable motor 18. Wheel 20 includes wings or holding element 50 which includes an indent or hole 52 that can be used to receive tablets 35 as shown in FIG. 12. Along with the plurality of wings 50 and indents 52, there are a plurality of slots 52 and housings 56 which are either cast into wheel 20 or machined into wheel 20 and are used to receive at least one actuator 70 shown in FIG. 10. In addition, there are a plurality of holes 58 which allow a shaft 74 to extend from sliding blocks 72 to cam wheels 73 (see FIG. 10) which can be positioned on an opposite side of wheel 20 than sliding blocks 72. Holes 58 are formed in an elongated manner so as to allow shaft 74 to slide axially out or in. In a radially inner region of these slots or housings 56, there is a spring receiving indent 59 which bends radially in, in a curved manner so that a spring 76 can rest inside and extend out therefrom. This spring 76 is held or laterally supported by this indent so that spring 76 can provide continuous support for block 72.

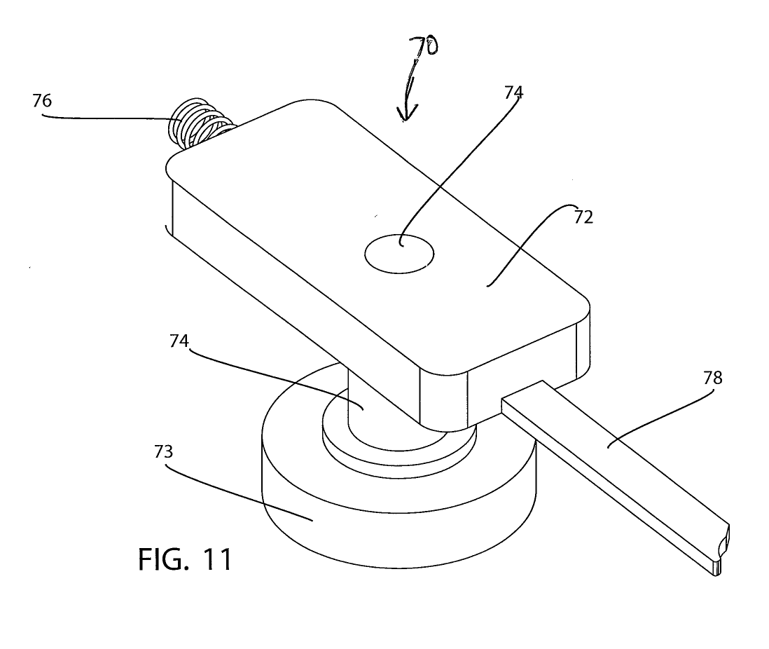

FIG. 10 is a perspective view of actuators 70 which include sliding blocks 72 and cam wheels 73 which are attached to sliding blocks 72 via a shaft 74. Sliding blocks 72 slide within housings 56 and each contain at least one spring 76 which is used to selectively activate sliding blocks 72. Spring 76 fits inside of indented housings 56 in a region of indent 59. Spring 76 acts to bias sliding block 72 towards a radially outside region on wheel 20. Actuators 70 also include an actuator arm 78 which fits inside of a corresponding slot 53 on wheel 20. Actuator arm 78 is slid back and forth inside of corresponding slot 53 wherein actuator arm 78 is used to hold a corresponding tablet or pill 35 in place in hole or slot 52. The features of actuator 70 are shown in greater detail in FIG. 11.

Notch 52 can be formed as a crescent or semi-circular shaped slot wherein this notch can be formed to receive a substantial portion of a rounded tablet or pill. The rounded edges of notch or hole 52 allows tablet or pill to reside in notch 52 while being supported by a shaft or actuator arm 78 which has a corresponding curved edge to wrap around this associated pill. The shape of this notch and the shape of the associated end of actuator arm 78 can be used to hold the associated tablet or pill in place. When the actuator arm 78 is moved out of place, then pill or tablet drops out and is released into either an accept shaft 32 or a reject shaft 34.

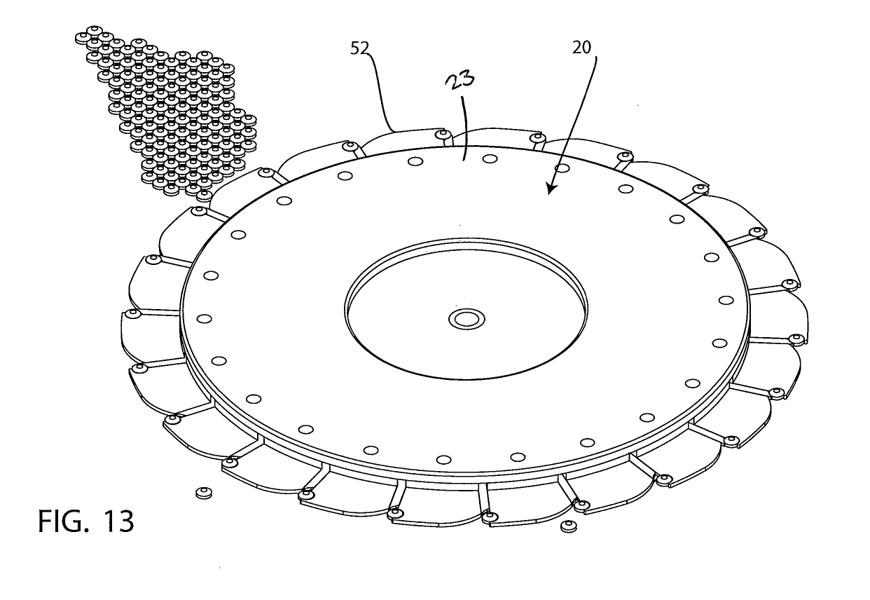

FIG. 12 shows a perspective view of wheel 20 wherein in this view, there is shown actuators 70 disposed inside of wheel 20 wherein these actuators 70 have springs 76 disposed in recessed region or indent 59 for receiving springs 76. As wheel 20 rotates, actuators 70 selectively contact one or more cams such as cam 26 to release tablets. FIG. 13 shows the wheel of FIG. 12 with a cover 23 disposed on top covering actuators 70.

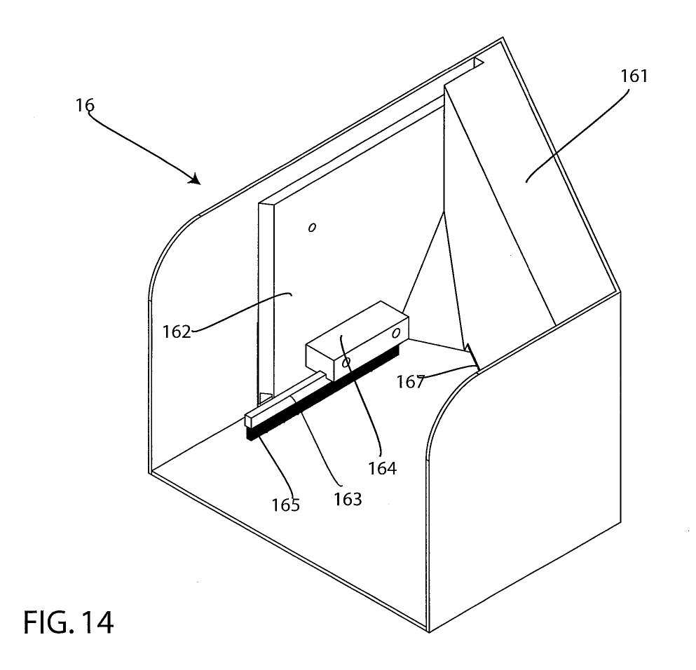

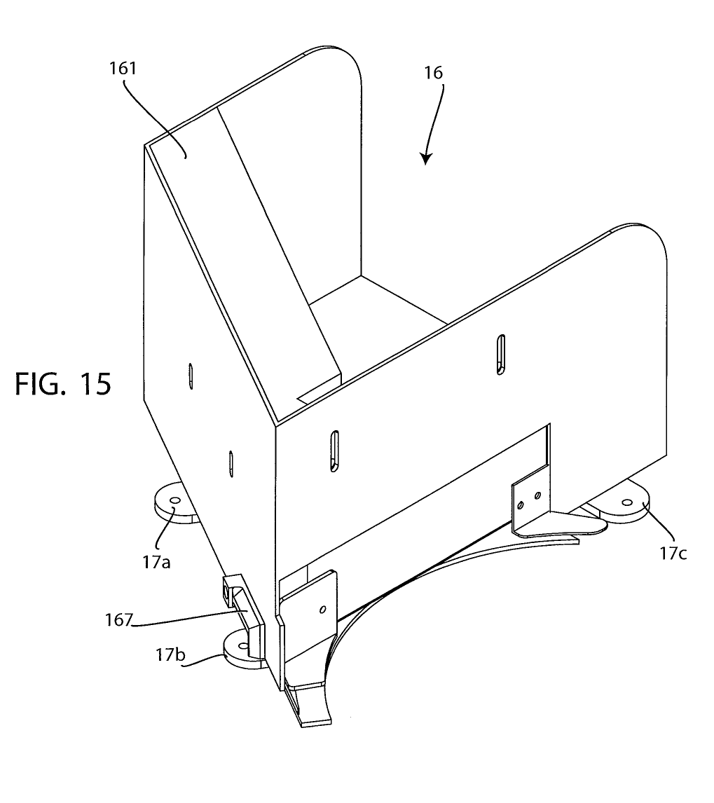

FIGS. 14 and 15 show two different perspective views of hopper 16 wherein hopper 16 includes a plurality of tabs 17a 17b and 17c which are used to allow hopper 16 to connect to columns 19a, 19b and 19d respectively.

Hopper 16 can also have a side panel 162, a plurality of side blocks 163 and 165, and a top block 164. There is also an additional panel 161 which can be used to help future tablets or pills through slot 167.

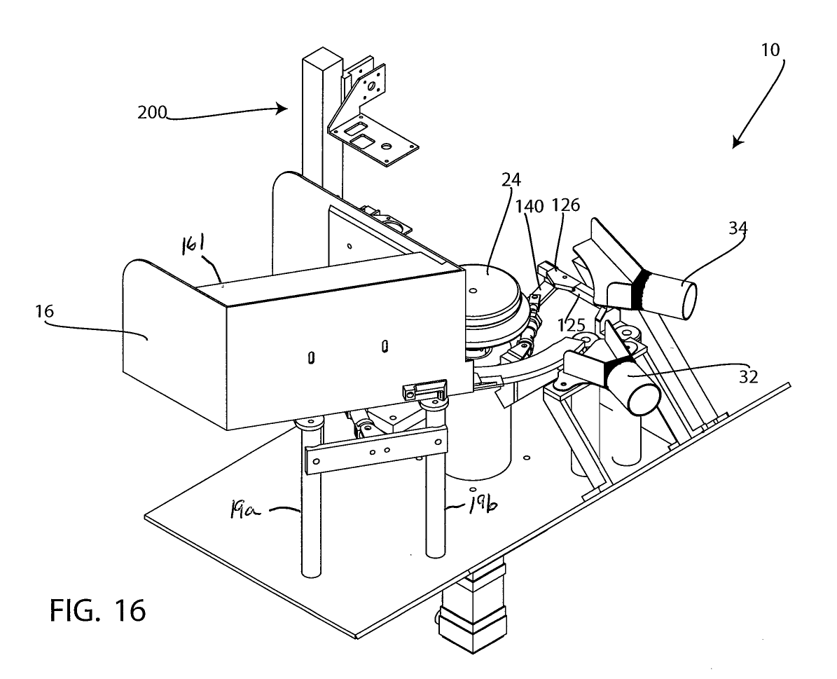

FIG. 16 shows hopper 16 coupled to columns 19a and 19b via tabs 17a and 17b, while this view also shows an additional cam system 126 which can be used to selectively release tablets or pills from wheel 20 so that these tablets or pills flow down a reject chute 34. Additional cam system 126 also contains additional piston 140 which can be used to selectively activate cam 125 to react with cam wheels 73 so that pills or tablets can be released into reject chute 34. If cam system 126 does not activate cam 125 then the tablets or pills 35 remain in wheel 20 and are only released into accept chute 32 via cam 26.

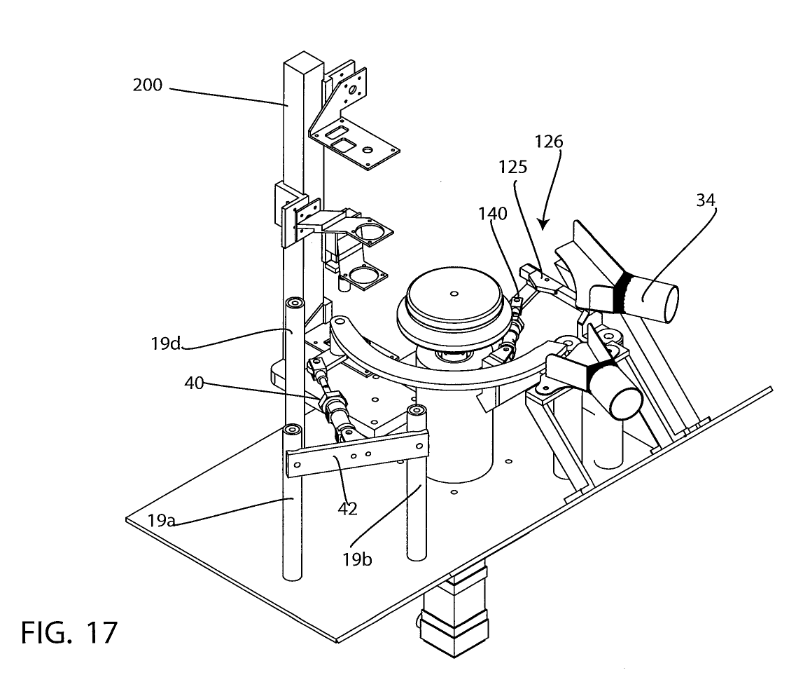

FIG. 17 is a perspective view of the device with the wheel removed. In this case, there is shown second cam system 126 which includes a piston 140 for activating this second cam system. A plurality of shafts 19a, 19b, and 19d are also shown wherein these shafts can be used to support a hopper 16 (not shown). Essentially, piston 140 is designed to receive signals from an associated computer as described in U.S. patent application Ser. No. 10/6927,631 and shown in FIG. 16 of that reference wherein the disclosure of which is incorporated by reference.

If piston 140 contracts, it causes cam 125 to contract into wheel 20 so that cam wheels 73 interact with cam 126 causing pills or tablets to be expelled into eject chute 34.

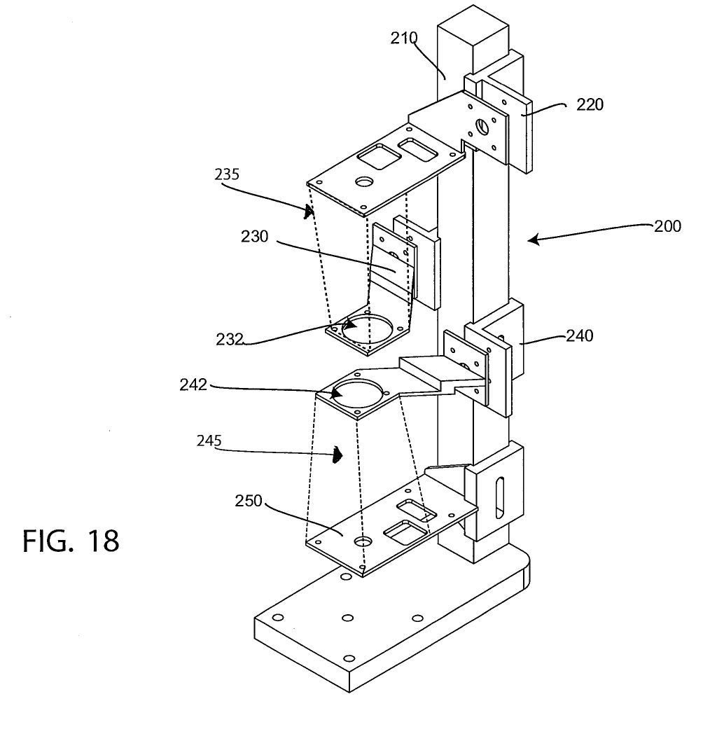

FIG. 17 also discloses optic stand 200 which is shown in greater detail in FIG. 18. FIG. 18 shows optic stand 200 which includes a column or shaft 210, a first bracket 220, which can be used to stabilize an optical recognition system such as a camera 235 or optical reading device such as an eye for analyzing a tablet. First bracket 220 is slidably coupled to column or shaft 210 so that it can be adjusted axially along shaft 210. In addition, a second bracket 230 can be slidably coupled to column 210 wherein second bracket 230 is a guiding bracket which can be used to aim and guide the above described optical device (not shown). Second bracket 230 can include an opening 232 which can be used to aim or point this type of electric eye.

An additional guiding bracket 240 is slidably coupled to a column 210 wherein this additional guiding bracket can be set to aim and control the aim of this electric or optical eye 245. A bottom bracket 250 is coupled to column 210 wherein this bottom bracket 250 can be used to support this optical eye 245 or camera shown by dashed lines in place. This bottom bracket 250 can be slidably coupled to column 210 and used to stabilize the optical eye 245 so that this optical eye can read a bottom side of a tablet 35 that is housed or contained in wheel 20.

Bracket 230 can have a plate which has a hole 232 for allowing an eye to scan there-through. In addition, bracket 240 can have a hole 242 which can be used to allow an optic or eye 245 to shine through onto a bottom side of an associated tablet.

In addition, the oppositely spaced optical eye or camera 235 can also be positioned so that it can read a top side of this pill or tablet 35 as well.

In use, the device or system operates as follows, pills are dumped or disposed in hopper 16. These pills are then drawn by gravity down to a hole or slot 167. The pills flow one by one through slot 167 and into individual notches 52 in wheel 20. At this point, actuator arm 74 is drawn back away from notch 52 so that notch 52 is positioned to receive these pills 35. During this time, wheel 20 rotates in a clockwise manner while being driven by rotating motor 18. At this point, the notch 52 containing the deposited pill rotates past cam 26 so that actuator wheel 73 which was being acted on by cam 26 now moves radially out with actuator block 72 to drive actuator arm 78 into a position to hold pill or tablet 35 in place in that particular notch 52.

As wheel 20 continues to rotate in a clockwise manner, that particular pill or tablet 35 then passes adjacent to optic stand or inspection station 200. Disposed in optic stand 200 are two cameras 235 and 245 wherein camera 235 is disposed above pill 35 while camera 245 is disposed below pill 35. These cameras are for viewing whether pill 35 has been properly treated wherein at least one side of pill 35 is struck with a laser to remove a portion of its coating. This laser treatment would occur using a different machine or system prior to placing the tablets in hopper 16. Once this pill or tablet has been reviewed, the images of this pill or tablet are compared with selected images stored by a remote computer. If the pill or tablet is in an acceptable condition, cam 125 of cam system 126 remains in place wherein that pill 35 disposed in wheel 20 rotates past discharge chute 34 without being discharged from wheel 20.

Instead, wheel 20 continues to rotate wherein a cam wheel 73 associated with that tablet 35 contacts cam 26 positioned at a bottom region of wheel 20 adjacent to accept chute 32. At this point, cam wheel 73 rolls over cam 26 and is directed radially inward towards a center region of wheel 20 so that actuator block 72 and actuator arm 78 draws away from notch 52 releasing tablet 35 into accept chute 32. Wheel 20 continues to rotate while cam wheel 73 is continuously acted upon until it reaches hopper 16 wherein notch 52 then receives an additional tablet for inspection.

Conversely, if during the rotation of wheel 20 cameras 235 and 245 detect a flawed tablet, then an associated computer would reject this tablet by instructing an associated piston 140 to move cam 126 into a region wherein it contact an associated cam wheels 73 to cause cam wheel to move actuator block 72 in a radially inward direction causing actuator arm 78 to release an associated tablet from wheel 20 into reject chute 34. At this point, to prevent any unauthorized tablets from being released, the computer would also send a signal to piston 40 to move so that cam 26 moves in a counter clockwise direction moving cam 26 away from cam wheels 73 so that the associated actuator arm remains in position keeping tablets 35 in wheel 20. In this way, this movement of cam 26 rotating around column 45 keeps imperfect tablets in place.

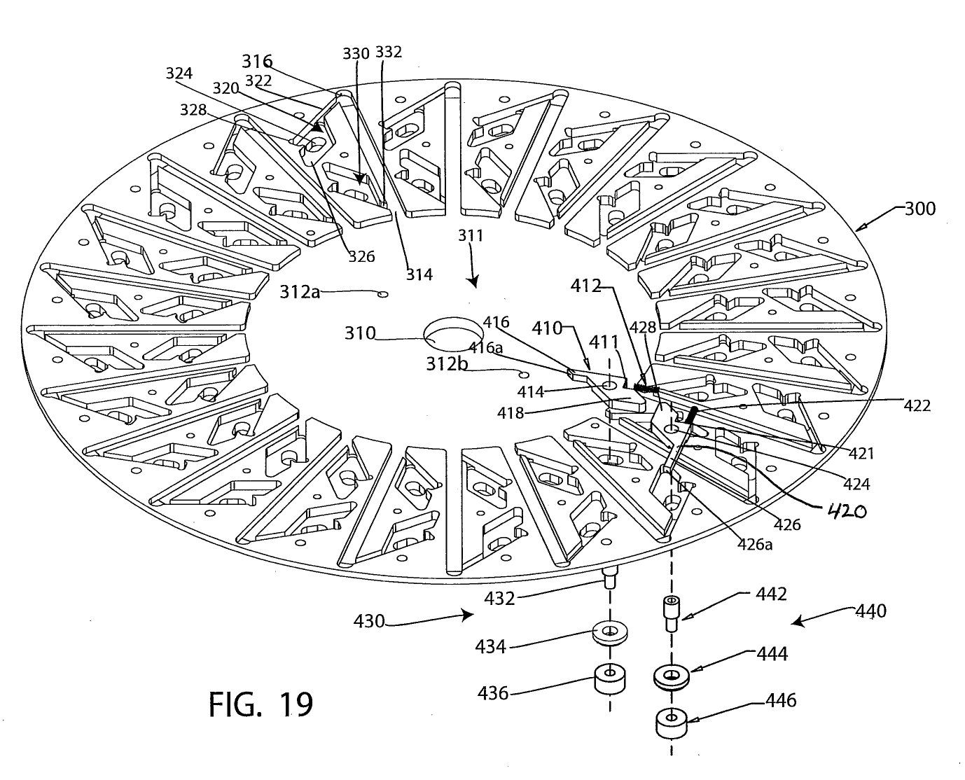

FIG. 19 shows a perspective view of another embodiment of the invention. In this view there is shown a new type wheel 300 which includes at least one push block 400 which can be in the form of a plurality of push blocks 410 and 420. These push blocks 410 and 420 are situated inside of sliding section 320 and 330 inside of wheel 300. Wheel 300 has a center hole 310 for coupling to a rotating drive, a center region 311 for receiving a hopper and a plurality of bolt holes 312a and 312b for coupling to a drive plate. There are also a plurality of open slots 314 which can be used to receive sliding pills or tablets disposed in a hopper and extending out from a center region 311. At the end of each of these slots, 314 there is an open hole 316 which can be used to allow a pill to drop therethrough into a distribution hopper.

So that wheel 300 can receive these blocks, there are cut out or recessed regions 320 and 330 to receive blocks 410 and 420. First cut out or recessed region 320 is disposed on a peripheral section of the wheel and includes a finger receiving region 322, a shaft sliding region 324, and a back block receiving region 326. There is also a spring cut out receiving region 328 which can be used to receive stabilize and guide a spring associated with a block. Second cut out region 330 which is disposed on an inner region of wheel 300, is shaped similar to first cut out region wherein second block cut out region includes a finger receiving region 332 which is shorter than finger receiving region 322 because an associated finger on a block is also shorter.

The two blocks 400 include a first block 410 and a second block 420 which can be substantially z-shaped. First block 410 is also disposed adjacent to a spring 412, wherein first block 410 includes a spring cut out section 411 which can be used to guide a spring, a hole 414 for receiving a shaft, a finger 416 extending out from a central region of block 410 and a back block section 418 disposed adjacent to spring 412 wherein finger 426 has a recess or indent or curve to receive a pill or tablet. For each of these slots 314 there can be a set of blocks 400.

The second block 420 can be in the form of a block that has a spring cut out region 421, with an associated spring 422 disposed adjacent to spring cut out region 421. There is also a shaft receiving hole 424 for receiving an associated shaft. An elongated finger 426 is coupled to second block 420 and extends out from the main body of this block. There is also an oppositely extending back block section 428 disposed adjacent to spring cut out region 421 and spring 422.

First block 410 fits inside of second section 330 wherein first block 410 is coupled in via a coupling shaft 432 which is coupled to block 410 and fits in and extends through hole 416. Shaft 432, is also coupled to a spacer 434 and to a roller 436. A shaft 442 is coupled to spacer 444 which is used to space roller 446 down to a region so that it can contact a dispensing cam 26 which is situated at the bottom of the angled rotation as shown in FIG. 6. First block 410 can be used to allow pills or tablets to be dispensed into slot 314 from a hopper while second block 420 regulates the dispensing of these pills or tablets out of slot 314 and into an accept or reject chute.

Essentially, the blocks work as follows: first block 410 sitting in second recess 330 is designed to keep pills or tablets from sliding out of slot 314 when the wheel which is angled at approximately 45 degrees is in its upward side of rotation. If first block 410 was not positioned in a closed position, then pills or tablets would slide out from slot 314 and back into the hopper. In this case, spring 412 presses against block 410 so that finger 416 extends out into recessed finger region 332, and into slot 314 to block the exit or entry of pills. When the wheel rotates so that this block is in a lower rotation section roller 436 interacts with a cam 26 so that block 410 is compressed against spring 412 causing finger 416 to recede into finger region 332 and out from slot 314 to allow a pill to enter into slot 314.

Second block 420 is designed to sit inside of first recessed region 320 and is used to control the release of pills from the wheel 300. Second block 420 has finger 426 which extends through recessed finger region 322 and into slot 314 to keep a pill or tablet from falling through hole 316. This block 420 is acted on by spring 422 to keep finger 426 in a normally closed position. However when block 420 on wheel 300 rotates into a downward position, it is acted on by cam 26 to push roller 446 back so that block 420 compresses against spring 422 to push finger 426 inward and away from slot 314 to allow a pill or tablet to move forward. Finger 426 is also dimensioned so that it can be acted upon to release only one pill at a time while keeping an adjacent pill retained in the slot. This is because the end portion 426a of finger 426 is curved so that at least one surface of this finger extends out into the slot 314 to retain the adjacent pill in the slot.

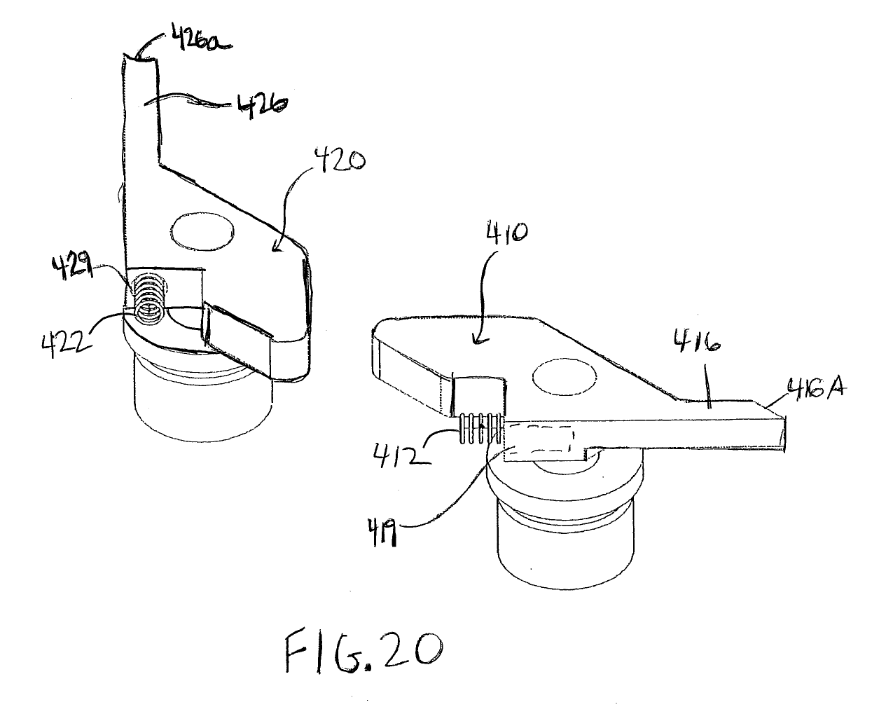

FIG. 20 shows a back end view and a side view of these two blocks 410 and 420. In this case, both blocks contain a recess 419 and 429 respectively, wherein these recesses are designed to receive a spring housed therein. These recesses are designed so that the spring rides therein and is stabilized inside of these recesses 419 and 429.

In addition, this view also shows the shape of the ends of each finger 416 and 426. Finger 416 has a flat angled end 416A designed to keep pills or tablets inside of the slot while finger 426 has a curved end 426a designed to wrap around and hold a particular pill or tablet in place. This feature is designed so that by holding the pill in place it can create a system where a particular end pill or tablet can be laser or mechanically drilled, coated, painted inscribed or viewed for analysis before deposition in another bin. In addition with this curved end 426a the finger can control a particular tablet so that only one tablet will fall through a slot 316.

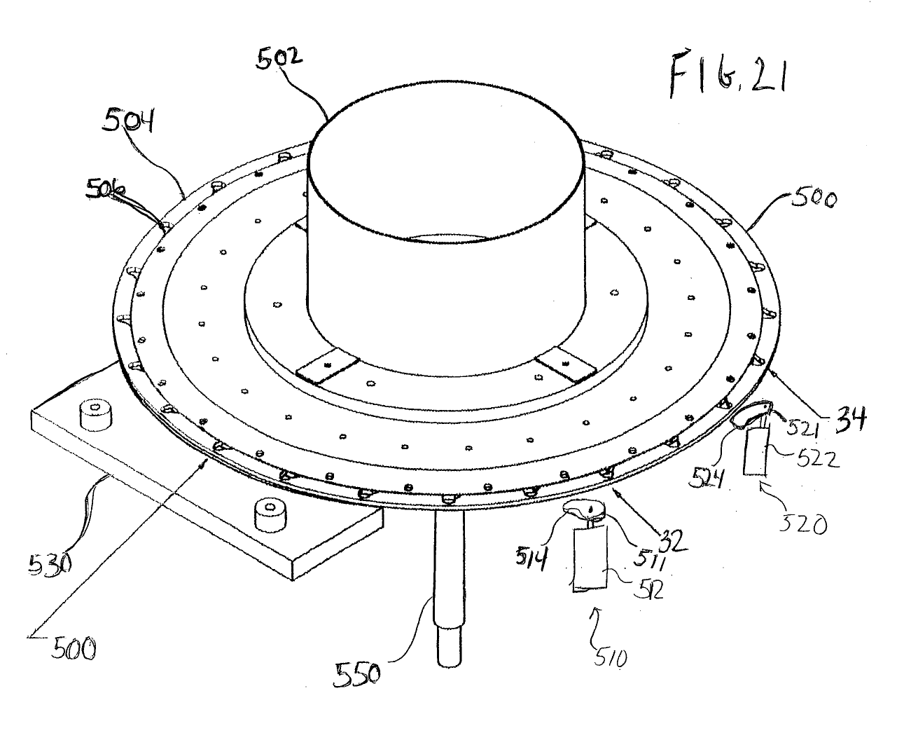

FIG. 21 is a perspective view of the base 500 which receives wheel 300. Base 500 includes a central hopper 502 which can be used to contain pills or tablets. This base 500 can also include a peripheral end 504 which has an end hole 506 disposed in this peripheral end. This hole can line up with peripheral hole 316 on wheel 300. There is also an adjustable cam eject system 510 disposed at eject region 32 wherein this eject system 510 is controlled by a central computer to selectively eject a pill or tablet from wheel 300. This device can include a solenoid 512 that is in communication with a central computer and a trigger finger, that includes a base 511 and an extending finger element 514 which can be selectively rotated out to activate or push in push roller 446 to at least partially release finger 426 to allow only one tablet to drop through hole 316 and through hole 506 and into a bin. This minor release movement still causes finger 426 to remain at least partially in slot 314 to keep the remaining pills or tablets fixed in this slot as that particular slot passes either a reject or an eject station. This feature then creates a system where only one pill will drop at a time from each slot as each slot passes either a reject or an eject station.

There is also a cam reject system 520 which is disposed at reject region 34 and which can be used to selectively reject a tablet from the system as the wheel 300 is rotating but before that pill or tablet reaches the eject region. Thus, there is a selectively activated solenoid 522 which can be selectively activated by a computer, a base 521 and a finger element 524 which can be selectively rotated out to contact a roller 446 or to be positioned in its normally retracted region so that an otherwise acceptable pill will pass the reject region and pass to the eject region where it is later ejected from the system. If however, the system detects that a particular pill should be rejected the computer can signal that cam solenoid 522 to rotate finger 524 to contact roller 446 to cause roller 446 to move to retract finger 426 to reject a tablet at the reject region. If a single pill is rejected from the reject region the next pill does not advance in that slot until it passes eject region 32 and onto cover plate 530.

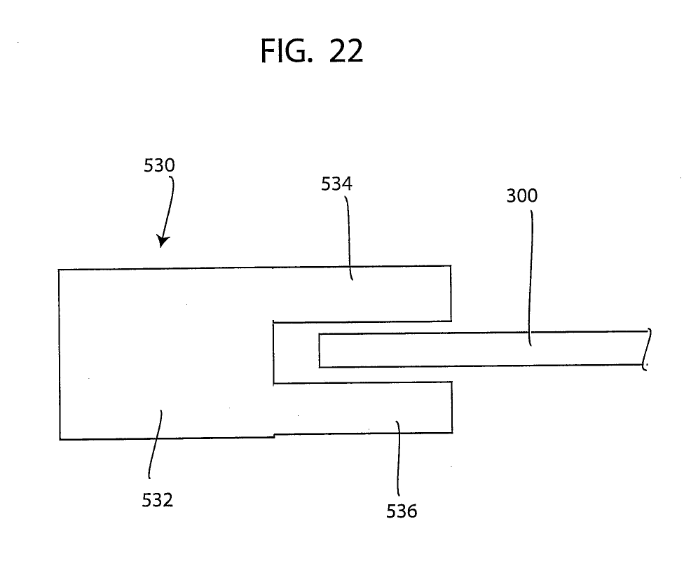

Cover plate 530 is disposed at a bottom region of the dispensing system. Cover plate 530 is shown in greater detail in a cross sectional view in FIG. 22. This cover plate can be made from any material but can be in the form of plastic an can cover both the top and bottom of wheel 300 via top cover 534 and bottom cover 536 which extend out from body 532. In this position, the pills are kept in place and kept from falling through holes 316 via bottom cover 536, while top cover 534 keeps these pills in from a top region. As these slots pass this cover plate rollers 436 and 446 contact activating cams 26 and 26a (See FIG. 6) at the bottom region of the rotation of the wheel. These activating cams are substantially stationary and can be used to automatically cause the blocks 410 and 420 to fully retract, causing pills or tablets to flow from hopper 502 into each slot 314 having a vacant opening to cause the slots to fill with tablets. Once the wheel passes this region, the activating rollers 436 and 446 are no longer in contact with these activating cams 26 and 26a so that the blocks 410 and 420 extend back into their resting positions with fingers 416 and 426 extending back into slot 314 thus fixing these pills in place.

Accordingly, while at least one embodiment of the present invention has been shown and described, it is to be understood that many changes and modifications may be made thereunto without departing from the spirit and scope of the invention as defined in the appended claims.

What is claimed is:

1. A system for dispensing items comprising:
a) a base;
b) at least one wheel rotatably coupled to said base;
c) at least two actuators slidably disposed in said at least one wheel, said at least two actuators for retaining at least one item to be dispensed from the system; and
d) at least one optical recognition system disposed adjacent to said wheel said optical recognition system for identifying at least one characteristic of the item to be dispensed to selectively actuate said at least one actuator to dispense said at least one item from said at least one wheel.

2. The system as claimed in claim 1, further comprising at least one accept chute disposed adjacent to said at least one wheel said at least one accept chute for receiving items being dispensed.

3. The system as claimed in claim 2, further comprising at least one reject chute disposed adjacent to said at least one wheel said at least one reject chute for selectively receiving items to be dispensed from the system.

4. The system as in claim 1, wherein said at least two actuators each further comprises at least one spring, for allowing said at least two actuators to be slidable in said wheel.

5. The system as in claim 4, wherein each of said at least two actuators comprise at least one actuator block coupled to said at least one spring, and at least one actuator arm coupled to said at least one actuator block, said at least one actuator arm for selectively retaining the item to be disposed in said at least one wheel.

6. The system as in claim 5, wherein said at least one wheel comprises at least one recess, at least one slot, and at least one wing having a notch, said at least one recess for receiving said at least one actuator block and said at least one spring, said at least one slot for receiving said at least one actuator arm and said at least notch for receiving the item to be dispensed wherein said item to be dispensed is held in place by said at least one actuator arm.

7. The system as in claim 1, further comprising at least one hopper for feeding items to be dispensed into a position adjacent to said at least one actuator.

8. The system as in claim 1, further comprising at least one cam for selectively actuating at least one of said at least two actuators, wherein said cam is for selectively dispensing the item to be dispensed from an associated wheel.

9. The system as in claim 1, further comprising at least one cam, disposed adjacent to said at least one wheel and coupled to said base, wherein said at least two actuators each comprises at least one actuator wheel wherein said at least one actuator wheel can be selectively contacted by said at least one cam to cause said at least one actuator to slide in said at least one wheel to dispense the item to be dispensed.

10. The system as in claim 1, further comprising an optical support element coupled to said stand wherein said at least one optical recognition system is coupled to said optical support element.

11. The system as in claim 10 wherein said optical support element is in the form of at least two holding elements with a first holding element for holding a first optical recognition element on one side of said at least one wheel and a second holding element for holding a second optical recognition element on an opposite side of said at least one wheel.

12. The system as in claim 1, further comprising at least one additional cam movably coupled to said base wherein said at least one additional cam is disposed adjacent to said at least one wheel.

13. The system as in claim 1, wherein said at least two actuators each comprise at least one actuator block that is substantially z-shaped.

14. The system as in claim 1, wherein said at least two actuators are disposed along said at least one slot in said at least one wheel.

15. A system for dispensing items comprising:
a) a base;
b) at least one wheel rotatably coupled to said base and having a plurality of slots;
c) at least two actuators slidably disposed along at least one of said slots in said at least one wheel, said at least two actuators for retaining at least one item to be dispensed from the system;
d) at least one optical recognition system disposed adjacent to said wheel said optical recognition system for identifying at least one characteristic of the item to be dispensed to selectively actuate sat least one of said at least two actuators to dispense said at least one item from said at least one wheel;
e) at least one accept chute disposed adjacent to said at least one wheel said at least one accept chute for receiving items being dispensed in response to being accepted by said at least one optical recognition system.
